(19) United States
(12) Patent Application Publication
(10) Pub. No.: US 2021/0264534 A1
(43) Pub. Date: Aug. 26, 2021

(54) GUIDING AGRIBUSINESS PRODUCER DECISIONS REGARDING FUTURES CONTRACTS

(71) Applicant: International Business Machines Corporation, Armonk, NY (US)

(72) Inventors: Carlos Eduardo Seo, Sao Paulo (BR); EDSON GOMES PEREIRA, Sao Paulo (BR); Marcel de Toledo Pineda, Santo Andre (BR); MARCELO MOTA MANHAES, Curitiba (BR); Tiago Dias Generoso, Poços de Caldas (BR)

(21) Appl. No.: 16/798,771

(22) Filed: Feb. 24, 2020

(51) Int. Cl. G06Q 40/08; G06Q 40/04; G06Q 30/06; G06N 3/08; G06F 40/30; G06F 40/211

(52) U.S. Cl. CPC G06Q 40/08; G06Q 40/04; G06Q 30/0623; G06F 40/211; G06Q 30/0643; G06N 3/08; G06F 40/30; G06Q 30/0631

(57) ABSTRACT

Guiding agribusiness producer prescriptive decisions is provided. A first risk coefficient and a first profit coefficient corresponding to selling a commodity via a traditional market and a second risk coefficient and a second profit coefficient corresponding to selling the commodity via a futures market are calculated. A minimized level of risk is calculated based on the first and second risk coefficient and information in a profile received from a producer of the commodity. A maximized level of profit is calculated based on the first and second profit coefficient and information in the profile received from the producer of the commodity. A recommendation is sent to a dashboard with a justification including calculations of the minimized level of risk and the maximized level of profit, a first percentage of the commodity to sell via the futures market and a second percentage of the commodity to sell via the traditional market.

### BACKGROUND

### 1. Field

The disclosure relates generally to commodities and more specifically to generating an improved graphical user interface for guiding agribusiness producer decisions regarding selling a particular commodity via a futures contract, a traditional cash market, or a combination of both.

### 2. Description of the Related Art

A commodity is an article of trade or commerce, especially a product as distinguished from a service. On a stock exchange a commodity is an unprocessed or partially processed good, such as, for example, grain, fruit, vegetable, coffee, precious metal, oil, or the like.

The quality of a given commodity may differ slightly, but it is essentially uniform across producers. Typically, the sale and purchase of commodities are carried out via futures contracts on exchanges that standardize the quantity and minimum quality of the commodity being traded. For example, the Chicago Board of Trade stipulates that one wheat futures contract is for 5,000 bushels and also states what grades of wheat can be used to satisfy the futures contract.

There are two types of traders that trade commodity futures. The first type are producers and buyers of commodities that use commodity futures contracts for hedging purposes. This first type of trader either makes delivery (e.g., the producer) or takes delivery (e.g., the buyer) of the commodity when the futures contract expires. For example, a wheat producer, such as a farmer or company, that plants a crop can hedge against the risk of losing money if the price of wheat falls before the crop is harvested. The wheat producer can sell wheat futures contracts when the crop is planted and guarantee a predetermined price for the wheat at the time it is harvested. The second type of commodities trader is a speculator. This second type of trader trades in the commodities markets for the sole purpose of profiting from volatile price movements. This second type of trader never intends to make or take delivery of the commodity when the futures contract expires.

### SUMMARY

According to one illustrative embodiment, a computer-implemented method for guiding agribusiness producer decisions is provided. A computer calculates a first risk coefficient and a first profit coefficient corresponding to selling a commodity via a traditional cash market and a second risk coefficient and a second profit coefficient corresponding to selling the commodity via a futures market using a set of trained artificial intelligence models having less than a predetermined maximum level of bias. The computer, using a first objective function, calculates a minimized level of risk based on the first risk coefficient and the second risk coefficient corresponding to selling the commodity in the traditional cash market and the futures market, respectively, and information in a profile received from a producer of the commodity. The computer, using a second objective function, calculates a maximized level of profit based on the first profit coefficient and the second profit coefficient corresponding to selling the commodity in the traditional cash market and the futures market, respectively, and information in the profile received from the producer of the commodity. The computer sends a recommendation to a dashboard display that includes calculations of the minimized level of risk and the maximized level of profit corresponding to the commodity, a first percentage of the commodity to sell via the futures market and a second percentage of the commodity to sell via the traditional cash market, estimated profit and associated risk level, a justification button that links to indexed recommendation justification document information used to derive the estimated profit and associated risk level, and a feedback button that enables the producer of the commodity to provide feedback regarding the recommendation. According to other illustrative embodiments, a computer system and computer program product for guiding agribusiness producer decisions are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is illustrates an example of a server components diagram in accordance with an illustrative embodiment;

FIG. 4 is illustrates an example of a process overview diagram in accordance with an illustrative embodiment;

FIG. 5 is a diagram illustrating an example of a data modeling process in accordance with an illustrative embodiment;

FIG. 6 is a diagram illustrating an example of an optimization process in accordance with an illustrative embodiment;

FIG. 7 is a diagram illustrating an example of a risk minimization process in accordance with an illustrative embodiment;

FIG. 8 is a diagram illustrating an example of a profit maximization process in accordance with an illustrative embodiment;

FIG. 9 is a diagram illustrating an example of a dashboard in accordance with an illustrative embodiment;

FIG. 10 is a flowchart illustrating a preparation process in accordance with an illustrative embodiment;

FIG. 11 is a flowchart illustrating an execution process in accordance with an illustrative embodiment; and

FIGS. 12A-12B are a flowchart illustrating a process for generating a commodity recommendation dashboard in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

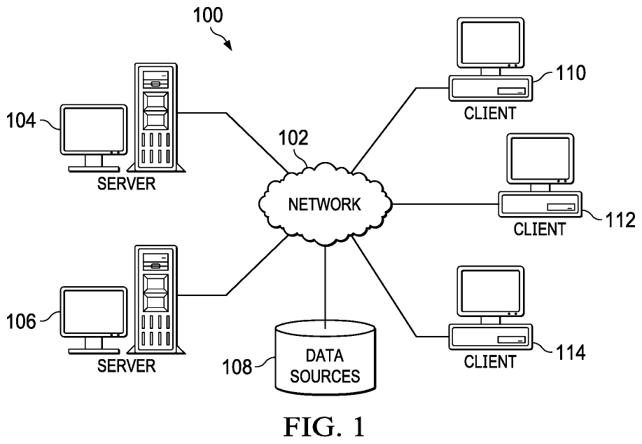

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, it should be noted that server 104 and server 106 may each represent a cluster of servers in one or more data centers. Alternatively, server 104 and server 106 may each represent multiple computing nodes in one or more cloud environments. In addition, server 104 and server 106 can provide artificial intelligence services for guiding agribusiness producers to make informed decisions regarding selling commodities via futures market, traditional cash market, or a combination of both based on analysis of information collected from a plurality of different data sources and information provided by the agribusiness producers.

Data sources 108 represent a plurality of different data sources capable of providing any type of data in a structured format or an unstructured format. In addition, data sources 108 may provide a plurality of different types of data, such as, for example, weather information, commodities prices, commodity production costs, financial news, economic forecasts, agribusiness news, futures contracts information, and the like. Server 104 and server 106 are capable of retrieving this information from data sources 108 to develop recommendations for the agribusiness producers regarding selling their commodity production at maximized profit and minimized risk.

Client 110, client 112, and client 114 also connect to network 102. Clients 110, 112, and 114 are clients of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102.

Users of clients 110, 112, and 114 may utilize clients 110, 112, and 114 to access the artificial intelligence services provided by server 104 and server 106. For example, a user, such as a subject matter expert, may utilize client 110 to input into server 104 and server 106 the identification of the plurality of different data sources represented by data sources 108. Users, such as agribusiness producers, may utilize clients 112 and 114 to provide server 104 and server 106 with profiles containing information corresponding to their respective commodities (i.e., crops), such as type, variety, quality, quantity, production costs, time to harvest, and the like, and to request the artificial intelligence services provided by server 104 and server 106 for making informed decisions regarding selling their commodities at a profit with minimized risk.

In addition, it should be noted that network data processing system 100 may include any number of additional servers, clients, storage devices, and other devices not shown. Program code located in network data processing system 100 may be stored on a computer readable storage medium and downloaded to a computer or other data processing device for use. For example, program code may be stored on a computer readable storage medium on server 104 and downloaded to client 110 over network 102 for use on client 110.

In the depicted example, network data processing system 100 may be implemented as a number of different types of communication networks, such as, for example, an internet, an intranet, a local area network (LAN), a wide area network (WAN), a telecommunications network, or any combination thereof. FIG. 1 is intended as an example only, and not as an architectural limitation for the different illustrative embodiments.

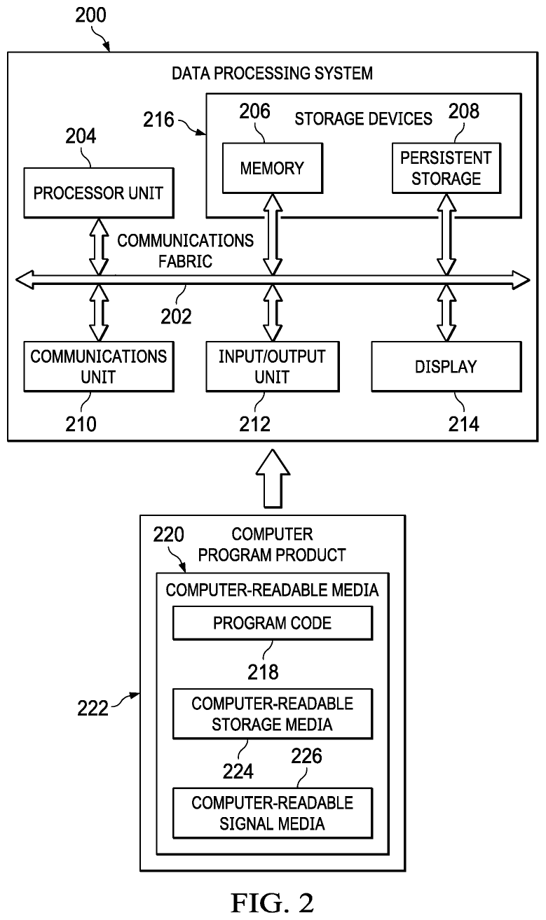

With reference now to FIG. 2, a diagram of a data processing system is depicted in accordance with an illustrative embodiment. Data processing system 200 is an example of a computer, such as server 104 in FIG. 1, in which computer readable program code or instructions implementing processes of illustrative embodiments may be located for guiding agribusiness producer decisions regarding selling a particular commodity via futures contract, traditional cash market, or a combination of both to achieve maximum profit at minimized risk. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. A computer readable storage device is any piece of hardware that is capable of storing information, such as, for example, without limitation, data, computer readable program code in functional form, and/or other suitable information either on a transient basis or a persistent basis. Further, a computer readable storage device excludes a propagation medium. Memory 206, in these examples, may be, for example, a random-access memory (RAM), or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity (Wi-Fi), Bluetooth® technology, global system for mobile communications (GSM), code division multiple access (CDMA), second-generation (2G), third-generation (3G), fourth-generation (4G), 4G Long Term Evolution (LTE), LTE Advanced, fifth-generation (5G), or any other wireless communication technology or standard to establish a wireless communications link for data processing system 200.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer readable program code that may be read and run by a processor in processor unit 204. The program instructions, in the different embodiments, may be embodied on different physical computer readable storage devices, such as memory 206 or persistent storage 208.

Program code 218 is located in a functional form on computer readable media 220 that is selectively removable and may be loaded onto or transferred to data processing system 200 for running by processor unit 204. Program code 218 and computer readable media 220 form computer program product 222. In one example, computer readable media 220 may be computer readable storage media 224 or computer readable signal media 226.

In these illustrative examples, computer readable storage media 224 is a physical or tangible storage device used to store program code 218 rather than a medium that propagates or transmits program code 218. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer readable media 220” can be singular or plural. For example, program code 218 can be located in computer readable media 220 in the form of a single storage device or system. In another example, program code 218 can be located in computer readable media 220 that is distributed in multiple data processing systems. In other words, some instructions in program code 218 can be located in one data processing system while other instructions in program code 218 can be located in one or more other data processing systems. For example, a portion of program code 218 can be located in computer readable media 220 in a server computer while another portion of program code 218 can be located in computer readable media 220 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 218.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

Agribusiness producers have to make prescriptive decisions as to whether to offer a commodity, such as a crop, on a tradition cash market now or wait to achieve a better price in the future. Generally, agriculture is an unstable market, more than other economic sectors, due to several factors, such as, for example, supply and demand, other commodities prices, weather, trade agreements, financial trends, agricultural prices, results of commodity production (e.g., commodity quantity and quality), and the like. Because of these factors, an agribusiness producer, such as a farmer or a company, is exposed to global commodity price fluctuations, which may cause financial uncertainty regarding the agribusiness producer's profits.

High price volatility may also impact crop production because high price volatility makes it difficult for agribusiness producers to know which crops to grow. To protect themselves from price volatility, agribusiness producers use multiple mechanisms, such as, for example, organizing themselves into cooperatives to share loss or profit, create risk management, and determine a minimum selling price based on production costs. Another mechanism to protect themselves is using futures contracts, also known as hedge commodities. Future contracts are an agreement between buyer and seller regarding commodity price on a given future date, with five standardized elements, the asset (commodity), the quantity, the quality, the delivery point, and the delivery date. This kind of contract has two parties: 1) hedgers (agribusiness producers) who want to protect the price of their products; and 2) speculators who want to bet on the prices of the products to obtain profits. The agribusiness producer sells the commodity according to an agreed price, locking in the price of the commodity, and the speculator buys the futures contract to bet on whether the price of the commodity will increase to obtain a profit.

As a result, futures contracts can be a good way to protect agribusiness producers from price volatility. However, futures contracts also involve risk. For example, it is estimated that agribusiness producers only receive between 75% and 80% of the actual futures price, which affects their profit.

Solutions already exist for helping futures contract traders on how to negotiate in the futures market. However, currently existing solutions neither help agribusiness producers to protect their product against price drops nor to sell their product with higher profits. Illustrative embodiments provide recommendations to help an agribusiness producer to size a futures contract, identify which percentage of the producer's production needs to be sold via a futures contract to cover production costs, but also to receive a higher profit on the production and help the producer control risk.

Illustrative embodiments determine maximum profit and minimum risk for the commodity to be sold via futures contract, informing the producer as to the justifications for such determinations, which allows the producer to make informed decisions. In addition, illustrative embodiments enable the producer to provide feedback regarding the recommendations based on the producer's experience, which enables illustrative embodiments to improve recommendations by retraining the artificial intelligence models using the feedback.

Illustrative embodiments take into account a plurality of factors, such as, for example, commodity profile information provided by the producer, weather information, transportation prices, production costs, storage conditions, current commodities prices, commodity price history over time, and the like, to determine minimum and maximum commodity selling prices. Based on this plurality of factors, illustrative embodiments generate artificial intelligence models that are capable of predicting price and percentage of production (covering different levels of risk) to be negotiated via futures contract and the justifications for those predictions. As a result, illustrative embodiments can provide a customized low-cost solution to guide agribusiness producers to make better decisions to cover production costs based on those predictions.

Illustrative embodiments collect information from a plurality of different data sources, such as, for example, commodity price variation history, actual production data, production costs history based on different time periods, scientific agribusiness articles, basic futures contract information, and the like, to support producer decision making regarding appropriate price and amount of the commodity to sell via futures contract and via a traditional cash market. Illustrative embodiments process the collected information utilizing techniques, such as, for example, data crawling, text analytics, data wrangling, data feature extraction, and the like. Then, illustrative embodiments utilize machine learning, such as artificial intelligence, and an optimization process to provide a result of the data analysis. Afterward, illustrative embodiments apply a fairness model to decrease or eliminate artificial intelligence bias. Subsequently, illustrative embodiments generate an improved user interface containing a set of recommendations with a justification for each recommendation, informing the producer of appropriate price, maximum and minimum percentage to negotiate via futures contract, and the like, which allows the agribusiness producer to make an informed decision.

As an example scenario, John Smith is a farmer (i.e., an agribusiness producer) with a history of producing a large amount of corn (i.e., a commodity) on his farm. However, Farmer Smith is experiencing low levels of profit because he is trying to negotiate the sale of his corn production directly with the buyers. As a result, Farmer Smith is searching for alternatives to improve the way he sells and delivers his corn production to increase profits. Farmer Smith also wants to create a more profitable ecosystem, even under unexpected events and conditions. A financial market is offering options to acquire the corn production at a fixed low price no matter what the actual price will be after harvest and guaranteeing payment. The price offered by the financial market will cover basic costs, but will not be enough to provide a real profit for Farmer Smith. On the other hand, Farmer Smith will not be spending time looking for buyers and will mitigate risk in case some unforeseen event causes decreased production. Farmer Smith is unsure as to the proper price to sell his corn in advance, before harvest. Waiting to sell after harvest can be risky because, for example, weather conditions may affect corn production quality and/or quantity or economic changes may affect the price negatively in such a way that Farmer Smith may not even be able to cover production costs. Consequently, Farmer Smith decides to utilize the artificial intelligence of illustrative embodiments to guide him in determining the proper price to sell his corn production via a futures market. Farmer Smith creates his profile, providing commodity information, production cost, and the like. Illustrative embodiments process the information in the profile, along with information from multiple data sources, such as, for example, different websites providing weather forecasts, economic and social news, scientific agribusiness articles, futures contract rules for commodities, and the like. After processing all of this information, illustrative embodiments provide a graphical user interface with recommendations to Farmer Smith regarding selling price, minimum and maximum percentages of the corn production to sell via futures contract and traditional cash market, and justifications for the recommended price and percentages. Thus, illustrative embodiments provide an improved user interface with useful recommendations to Farmer Smith allowing him to consider what percentage can be committed to the financial market to ensure that basic production costs can be recovered and what percentage can be negotiated with a regular cash contract to increase the margin of profit. Farmer Smith decides to follow a recommendation that offers a medium level of risk by selling 67% of his corn production via a futures market. Using this approach, Farmer Smith is ensured of recovering his production costs and increasing his profit margin.

Thus, illustrative embodiments provide one or more technical solutions that overcome a technical problem with generating an improved graphical user interface for instructing an agribusiness producer on how to maximize profit and minimize risk associated with selling a commodity via a combination of futures contracts and traditional cash market. As a result, these one or more technical solutions provide a technical effect and practical application in the field of user interfaces.

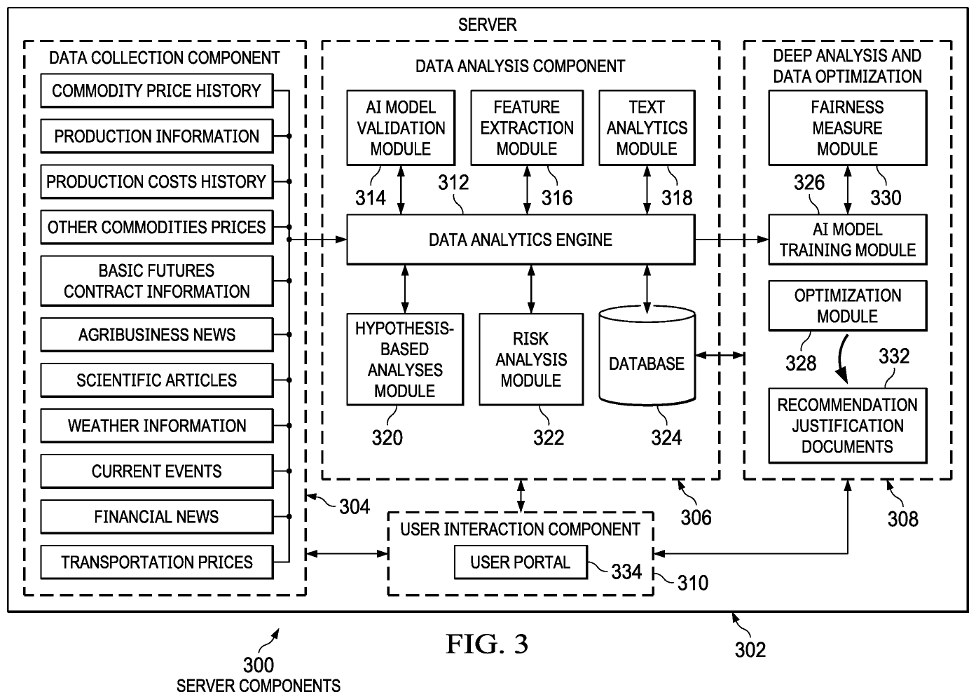

With reference now to FIG. 3, an example of server components is depicted in accordance with an illustrative embodiment. Server components 300 are implemented in server 302. Sever 302 may be, for example, server 104 in FIG. 1 or data processing system 200 in FIG. 2. Server components 300 represent a collection of software components for guiding agribusiness producer decisions regarding selling a particular commodity via futures market, traditional cash market, or a combination of both futures market and traditional cash market to maximize profit and minimize risk. Server components 300 perform data collection, data analysis, artificial intelligence model training, deep analysis and data optimization, and user interaction.

In this example, server components 300 include data collection component 304, data analysis component 306, deep analysis and data optimization component 308, and user interaction component 310. However, it should be noted that server components 300 may include more or fewer components than illustrated. For example, a component may be divided into two or more components, two or more components may be combined into one component, one or more components not shown may be added, or one or more components shown may be removed.

Data collection component 304 is responsible for identifying which data dimensions are needed and for collecting that data from appropriate data dimension sources. In this example, data collection component 304 collects commodity price history, production information such as quality and quantity, production costs history, other commodities prices, basic futures contracts information, agribusiness news, scientific articles, weather information, current events, financial news, and transportation prices. Data collection component 304 sends the collected data to data analysis component 306.

Data analysis component 306 is responsible for processing the collected data. In this example, data analysis component 306 includes data analytics engine 312, artificial intelligence model validation module 314, feature extraction module 316, text analytics module 318, hypothesis-based analyses module 320, risk analysis module 322, and database 324. Data analytics engine 312 processes inputs received from artificial intelligence model validation module 314, feature extraction module 316, text analytics module 318, hypothesis-based analyses module 320, risk analysis module 322, and database 324.

Feature extraction module 316 extracts features from the collected data to identify meaning of the collected data. Text analytics module 318 analyzes the collected data for syntax, semantics, and the like. Hypothesis-based analyses module 320 generates hypotheses regarding the collected data for making predictions. Risk analysis module 322 calculates different levels of risk associated with the different dimensions of the collected data. Database 324 stores historical and consolidated data across the different data dimensions in a predetermined format. Artificial intelligence model validation module 314 validates and retrains artificial intelligence models corresponding to each of the different data dimensions.

Data analytics engine 312 sends this processed data to deep analysis and data optimization component 308. Deep analysis and data optimization component 308 is responsible for training the artificial intelligence models using artificial intelligence model training module 326 and for improving the data analysis received from data analytics engine 312 using optimization module 328. Further, deep analysis and data optimization component 308 is responsible for decreasing or eliminating artificial intelligence model bias using fairness measure module 330. Fairness measure module 330 iteratively applies a fairness model to each of the artificial intelligence models until each artificial intelligence model has less than a predetermined maximum level of bias. Furthermore, deep analysis and data optimization component 308 is responsible for providing recommendation justification documents 332 based on the optimized data output of optimization module 328. Recommendation justification documents 332 enable agribusiness producer interaction by providing a rational for each recommendation.

User interaction component 310 is responsible for extracting feedback regarding the agribusiness producer's experience in order to improve producer decision guidance. User interaction component 310 includes user portal 334. User portal 334 provides a graphical dashboard display of the set of recommendation results with justification for each recommendation to the agribusiness producers. The dashboard display also provides a feedback button for an agribusiness producer to provide feedback regarding a selected recommendation.

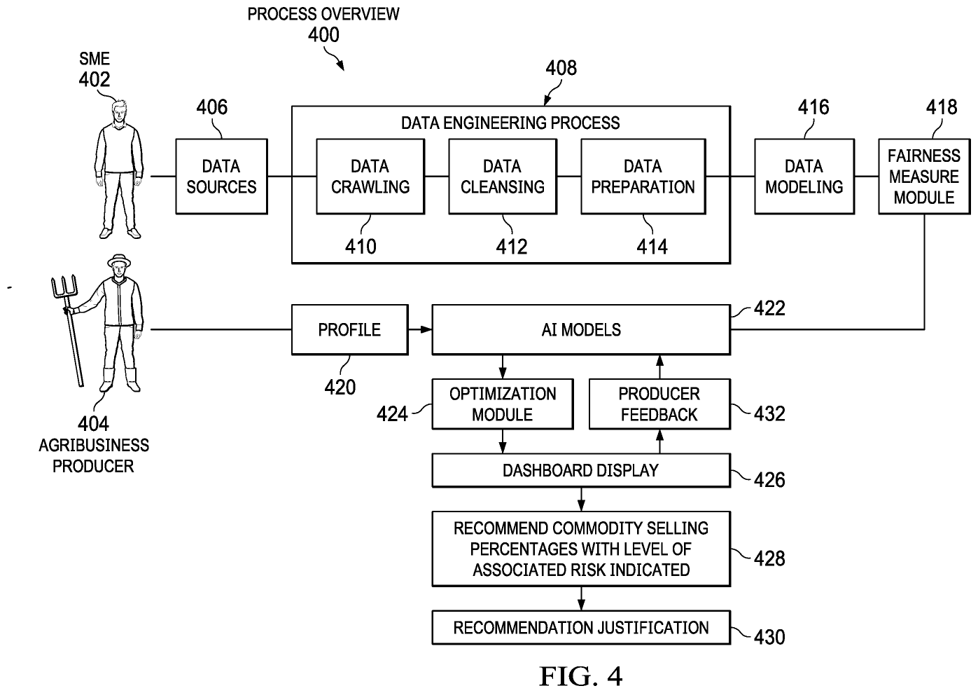

With reference now to FIG. 4, an example of a process overview is depicted in accordance with an illustrative embodiment. Process overview 400 may be implemented in a server computer, such as, for example, server 104 in FIG. 1, data processing system 200 in FIG. 2, or server 302 in FIG. 3.

Process overview 400 includes subject matter expert (“SME”) 402 and agribusiness producer 404. Subject matter expert 402 is an expert in the area of commodities. Agribusiness producer 404 is a producer of a commodity, such as, for example, wheat, and may be an individual or a company.

Subject matter expert 402 identifies data sources 406 and inputs the identification of data sources 406 into data engineering process 408 of the server. Data sources 406 may be, for example, data sources 108 in FIG. 1. Data sources 406 represent a plurality of different sources of information across a plurality of different data dimensions associated with the commodity grown by agribusiness producer 404.

Data engineering process 408 processes the data from all of the different data dimensions, such as, for example, commodity information, production costs, weather forecasts, current events, agribusiness news, social news, economic news, scientific agribusiness articles, futures contract rules, and the like. Data engineering process 408 utilizes data crawling 410, data cleansing 412, and data preparation 414 to collect, cleanup, and normalize the collected data. Data crawling 410 retrieves relevant information from data sources 406, such as, for example, websites, which subject matter expert 402 previously identified.

Data modeling 416 utilizes natural language processing, such as feature extraction, language identification, syntax processing, semantic parsing, and the like, to identify relevant information. Feature extraction may include identification of sentiment and tone in order to enrich the data dimensions regarding the related text. For example, if sentiment regarding economic news corresponding to a particular commodity is positive, negative, or neutral, the sentiment generates a feature input (e.g., sentiment score) into an economic data dimension artificial intelligence model regarding that particular commodity. After feature extraction is performed, data modeling 416 consolidates the data across each data dimension into a predetermined (e.g., unique) format. The consolidated data across data dimensions represent structured information that is input into artificial intelligence (“AI”) models 422. Artificial intelligence models 422 include an artificial intelligence model for each respective data dimension.

Another function of feature extraction is to generate recommendation justification documents. These recommendation justification documents represent unstructured information that is related to the structured information inputted into artificial intelligence models 422. The server indexes the recommendation justification documents with corresponding data source information. The server also enriches the recommendation justification documents with sentiment and tone, which the server utilizes in dashboard display 426 to justify recommendations regarding futures market negotiation.

Agribusiness producer 404 creates profile 420, which includes information regarding the commodity grown and projected production of the commodity. Agribusiness producer 404 sends profile 420 to the server and the server inputs the information in profile 420 into artificial intelligence models 422. The server utilizes fairness measure module 418 to apply a fairness model to artificial intelligence models 422 to remove or reduce bias in each artificial intelligence model corresponding to a data dimension.

The server utilizes optimization module 424 to optimize the output of artificial intelligence models 422 to minimize risk and maximize profit using different objective functions. The server generates dashboard display 426 with commodity information collected from profile 420 and recommended strategy to sell the commodity, such as, for example, percentage to sell via futures market and percentage to sell via traditional cash market, and a level of risk associated with the recommended strategy 428. Dashboard display 426 also includes recommendation justification 430. Recommendation justification 430 is the justification, rational, or basis for providing the recommended strategy. Dashboard display 426 further includes a feedback button for the agribusiness producer to provide producer feedback 432 to the server. The server can utilize producer feedback 432 to retrain artificial intelligence models 422.

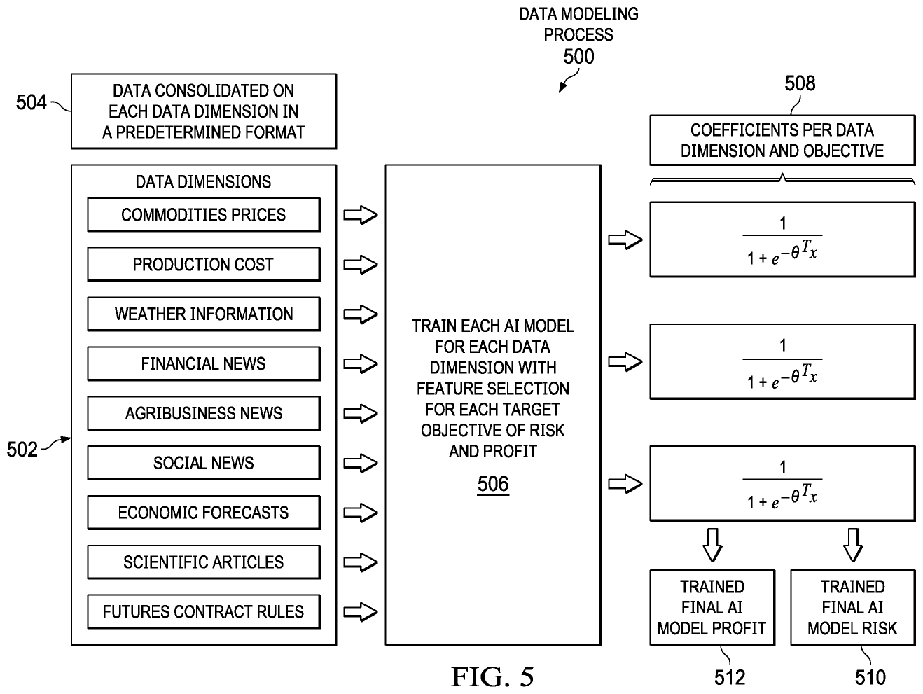

With reference now to FIG. 5, a diagram illustrating an example of a data modeling process is depicted in accordance with an illustrative embodiment. Data modeling process 500 may be implemented in a server computer, such as, for example, server 104 in FIG. 1, data processing system 200 in FIG. 2, or server 302 in FIG. 3.

Data modeling process 500 trains each artificial intelligence model corresponding to each respective data dimension in data dimensions 502 based on crawled, cleaned, transformed, and enriched data from previous processes. In this example, data dimensions 502 include commodities prices, production cost, weather information, financial news, agribusiness news, social news, economic forecasts, scientific articles, and futures contract rules. Data modeling process 500 processes the input data (i.e., the information contained in data dimensions 502) for data modeling by selecting relevant features for each data dimension (e.g., economic, social, weather, price, and the like) and each target objective of risk and profit.

At 504, data modeling process 500 consolidates the input data across each data dimension in a predetermined format. At 506, data modeling process 500 trains each artificial intelligence model corresponding to a data dimension based on relevant feature selection for each target objective of risk and profit. At 508, data modeling process 500 calculates coefficients per data dimension and target objective. At 510, data modeling process 500 generates trained final artificial intelligence model risk based on the calculated coefficients for risk per data dimension. At 512, data modeling process 500 generates trained final artificial intelligence model profit based on the calculated coefficients for profit per data dimension.

Data modeling process 500 centralizes all data dimension training sets by commodity including type and variety. Data modeling process 500 trains an artificial intelligence model using training, validation, and testing datasets. In addition, data modeling process 500 iteratively executes each artificial intelligence model to achieve predetermined threshold values for precision, recall, and F1 score. The subject matter expert validates against minimum performance requirements. If not consistent, data modeling process 500 can retrain the artificial intelligence model until an acceptable performance level is reached. Afterward, data modeling process 500 executes a final validation step using a fairness model. The fairness model executes validation and corrections on the trained artificial intelligence model to make sure that the trained artificial intelligence model has no bias.

If the fairness model finds bias in a trained artificial intelligence model, the fairness model provides interactions to eliminate bias by correcting the trained artificial intelligence model until it is ready to be used on its corresponding data dimension and for each target objective (i.e., profit and risk) regarding futures market percentage of negotiation. With the trained artificial intelligence models ready to deliver coefficients for profit and risk, the next process is optimization.

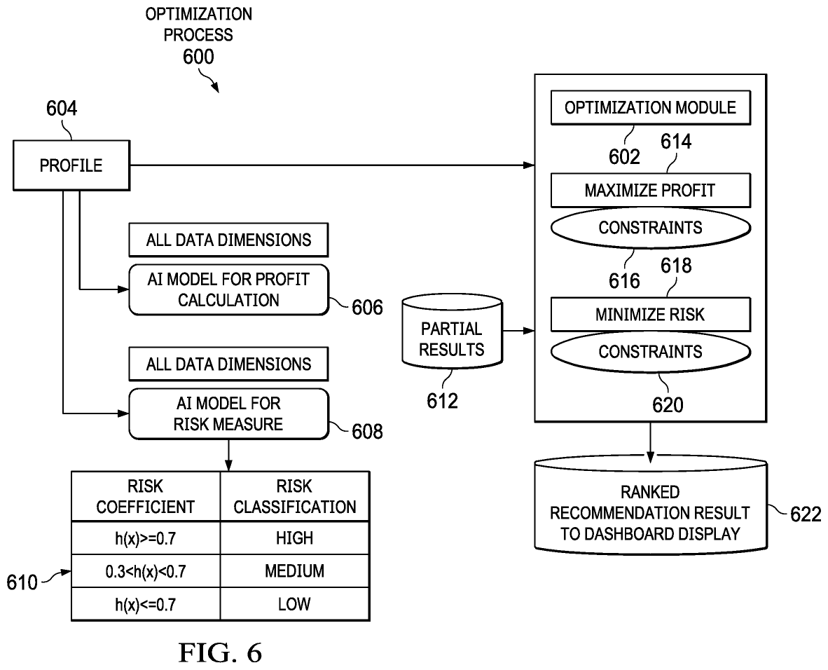

With reference now to FIG. 6, a diagram illustrating an example of an optimization process is depicted in accordance with an illustrative embodiment. Optimization process 600 may be implemented in a server computer, such as, for example, server 104 in FIG. 1, data processing system 200 in FIG. 2, or server 302 in FIG. 3.

Optimization process 600 includes optimization module 602. Optimization process 600 comprises two subprocesses: 1) profit maximization; and 2) risk minimization. Optimization process 600 uses as inputs the data feed from profile 604 and coefficients generated by artificial intelligence model for profit calculation 606 across all data dimensions and coefficients generated by artificial intelligence model for risk measure 608 across all the data dimensions.

Optimization module 602 receives the inputs from profile 604, which includes predicted commodity production capacity that will be sold, and artificial intelligence model results for the defined commodity on each consolidated data dimension, such as, for example, economic, financial, weather, and the like, for target objectives risk and profit. Artificial intelligence model for risk measure 608, which feeds optimization module 602, calculates a risk coefficient between 0 and 1. In this example, table 610 indicates that a risk coefficient greater than or equal to 0.7 is a high-risk classification, a risk coefficient less than 0.7 and greater than 0.3 is a medium-risk classification, and a risk coefficient less than or equal to 0.3 is a low-risk classification.

Coefficient output of artificial intelligence model for profit calculation 606 and artificial intelligence model for risk measure 608 comprise partial result 612. Optimization process 600 inputs partial result 612 into optimization module 602, along with the information in profile 604. Optimization module 602 generates two objective functions: one to maximize profit and the second to minimize risk. At 614, optimization module 602 maximizes profit based on constraints 616. In addition, at 618, optimization module 602 minimizes risk based on constraints 620. Afterward, at 622, optimization module 602 outputs a ranked recommendation result to a dashboard display for the agribusiness producer to review.

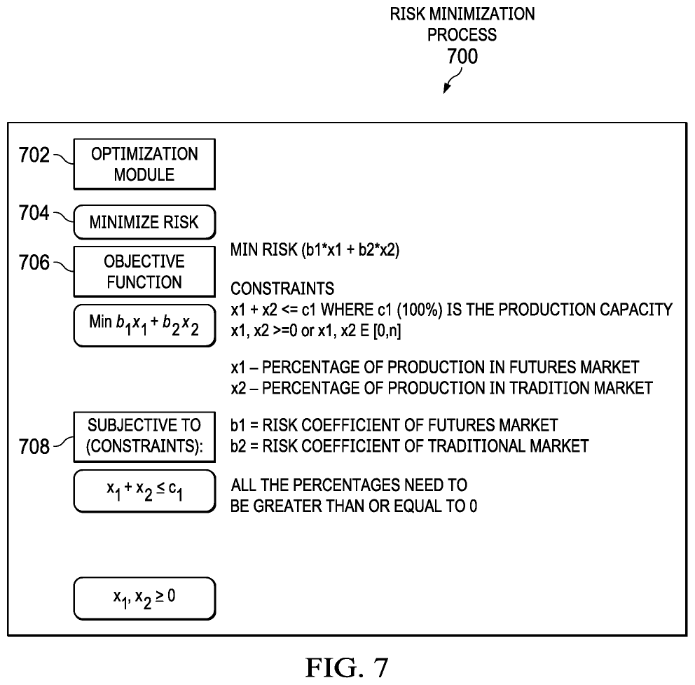

With reference now to FIG. 7, a diagram illustrating an example of a risk minimization process is depicted in accordance with an illustrative embodiment. Risk minimization process 700 may be implemented in a server computer, such as, for example, server 104 in FIG. 1, data processing system 200 in FIG. 2, or server 302 in FIG. 3.

Risk minimization process 700 includes optimization module 702. Minimize risk optimization 704 comprises objective function 706 (Min Risk (b1*x1+b2*x2)), where b1 is the risk coefficient of the futures market and b2 is the risk coefficient of the traditional cash market. Both coefficient values are obtained from an artificial intelligence model risk, such as, for example, trained final artificial intelligence model risk 510 in FIG. 5. x1 and x2 are percentage amounts of commodity production to sell on the futures market and the traditional cash market, respectively. All percentages need to be greater than or equal to 0.

Minimize risk optimization 704 is subject to constraints 708, where x1+x2 needs to be less than or equal to c1. c1 is the production capacity in percentage. The production capacity can be 100% or less and is defined in the profile created by the agribusiness producer, such as agribusiness producer 404 in FIG. 4. It should be noted that optimization module 702 treats the minimization of risk as a dual problem associated with a linear programmer problem of maximized profit (e.g., a primal problem).

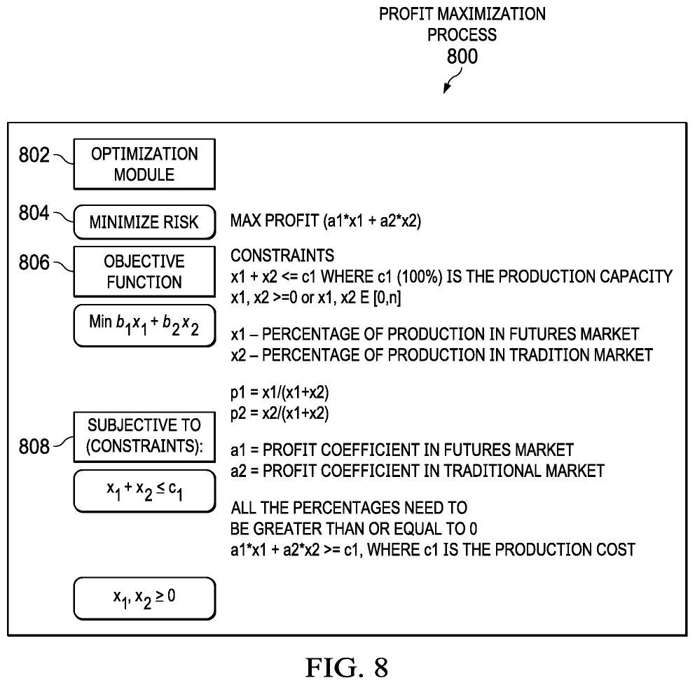

With reference now to FIG. 8, a diagram illustrating an example of a profit maximization process is depicted in accordance with an illustrative embodiment. Profit maximization process 800 may be implemented in a server computer, such as, for example, server 104 in FIG. 1, data processing system 200 in FIG. 2, or server 302 in FIG. 3.

Profit maximization process 800 includes optimization module 802. Maximize profit optimization 804 comprises objective function 806 (Max Profit (a1*x1+a2*x2)), where a1 is the price coefficient in the futures market and a2 is the price coefficient in the traditional cash market. Both coefficient values are obtained from the artificial intelligence model commodities price prediction, such as, for example, trained final artificial intelligence model profit 512 in FIG. 5. x1 and x2 are the percentage amounts from the commodity production capacity to be sold on the futures market and the traditional cash market, respectively. All percentages need to be greater than or equal to 0. The commodity production capacity is defined in the profile created by the agribusiness producer, such as agribusiness producer 404 in FIG. 4.

Maximize profit optimization 804 is subject to constraints 808, where x1+x2 needs to be less than or equal to b1, which is the production capacity. Constraints also include that a1*x1+a2*x2>=c1, where c1 is the production cost. It should be noted that objective function 806 for profit maximization is different from objective function 706 in FIG. 7 for risk minimization.

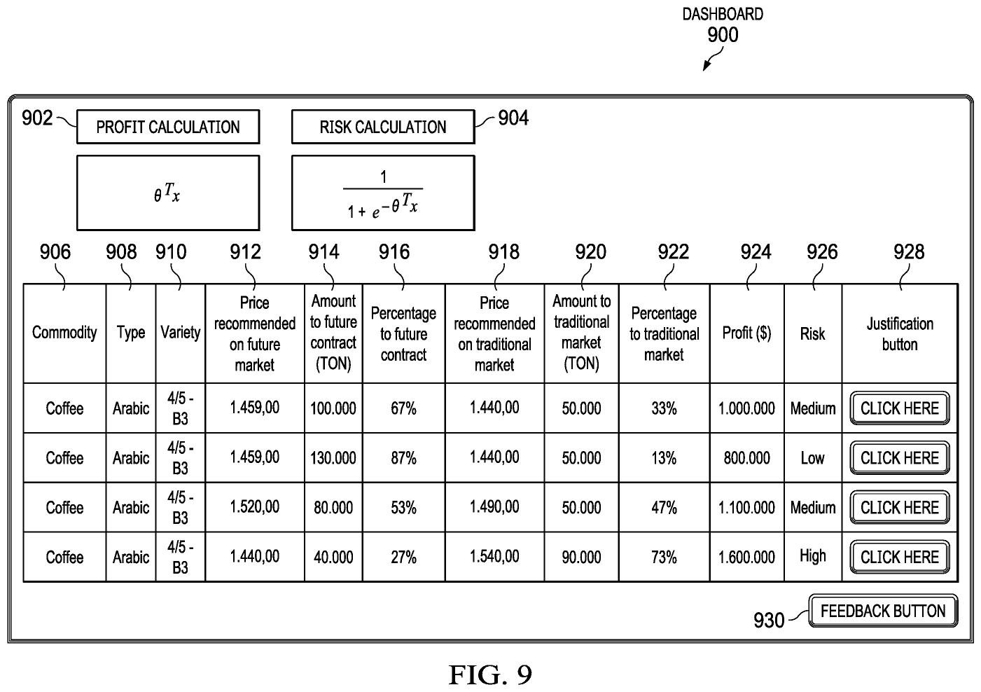

With reference now to FIG. 9, a diagram illustrating an example of a dashboard is depicted in accordance with an illustrative embodiment. Dashboard 900 may be implemented in a user portal, such as, for example, user portal 334 in FIG. 3 and displayed on a client device, such as, for example, client 112 in FIG. 1. Dashboard 900 is an improved graphical user interface that guides decisions of an agribusiness producer regarding selling a particular commodity via a combination of futures market and traditional cash market.

After optimization calculations in terms of profit and risk are combined, an optimization module, such as, for example, optimization module 602 in FIG. 6, delivers a final dashboard of recommendation results, such as dashboard 900. Dashboard 900 corresponds to the commodity described in a profile created by an agribusiness producer, such as, for example, profile 420 created by agribusiness producer 404 in FIG. 4.

In this example, dashboard 900 includes profit calculation 902, risk calculation 904, commodity 906, type 908, and variety 910. Commodity 906 in this example is coffee, type 908 is Arabic, and variety 910 is 4/5-B3.

Regarding the futures market, dashboard 900 shows price recommended on futures market 912, amount to futures market (tons) 914, and percentage to futures contract 916. Regarding the traditional cash market, dashboard 900 shows price recommended on traditional market 918, amount to traditional market (tons) 920, and percentage to traditional market 922.

In a consolidation section, dashboard 900 shows predicted profit 924 and risk 926 for each respective recommendation. Risk 926 is a risk (“r(x)”) classification. When r(x) is >=0.7, the risk classification is high. When 0.3<=r(x)<=0.7, the risk classification is medium. When r(x) is <=0.3, the risk classification is low.

Dashboard 900 also provides justification button 928 for each individual recommendation. Each justification button 928 retrieves natural language processed data in the form of recommendation justification documents. These recommendation justification documents were previously indexed and arranged to show to the agribusiness producer the hypothesis or rationale to support the values of each respective recommendation. In addition, dashboard 900 includes feedback button 930. Feedback button 930 enables the agribusiness producer to send feedback regarding the recommendation results as to whether the recommendations were valuable or not. Illustrative embodiments process the feedback and utilize the feedback as input to retrain the artificial intelligence models, such as producer feedback 432 is utilized to retrain artificial intelligence models 422 in FIG. 4.

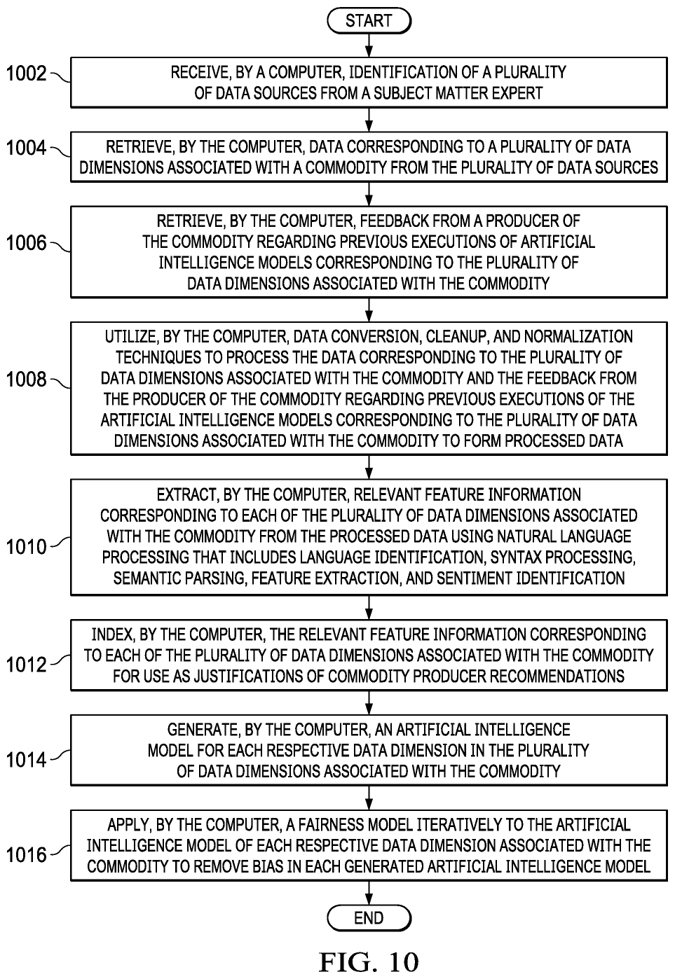

With reference now to FIG. 10, a flowchart illustrating a preparation process is shown in accordance with an illustrative embodiment. The process shown in FIG. 10 may be implemented in a computer, such as, for example, server 104 in FIG. 1, data processing system 200 in FIG. 2, or server 302 in FIG. 3.

The process begins when the computer receives identification of a plurality of data sources from a subject matter expert (step 1002). The computer retrieves data corresponding to a plurality of data dimensions associated with a commodity from the plurality of data sources (step 1004). The computer also retrieves feedback from a producer of the commodity regarding previous executions of artificial intelligence models corresponding to the plurality of data dimensions associated with the commodity (step 1006).

The computer utilizes data conversion, cleanup, and normalization techniques to process the data corresponding to the plurality of data dimensions associated with the commodity and the feedback from the producer of the commodity regarding previous executions of the artificial intelligence models corresponding to the plurality of data dimensions associated with the commodity to form processed data (step 1008). The computer extracts relevant feature information corresponding to each of the plurality of data dimensions associated with the commodity from the processed data using natural language processing that includes language identification, syntax processing, semantic parsing, feature extraction, and sentiment identification (step 1010). The computer indexes the relevant feature information corresponding to each of the plurality of data dimensions associated with the commodity for use as justifications of commodity producer recommendations (step 1012).

The computer generates an artificial intelligence model for each respective data dimension in the plurality of data dimensions associated with the commodity (step 1014). The computer applies a fairness model iteratively to the artificial intelligence model of each respective data dimension associated with the commodity to remove bias in each generated artificial intelligence model (step 1016). Thereafter, the process terminates.

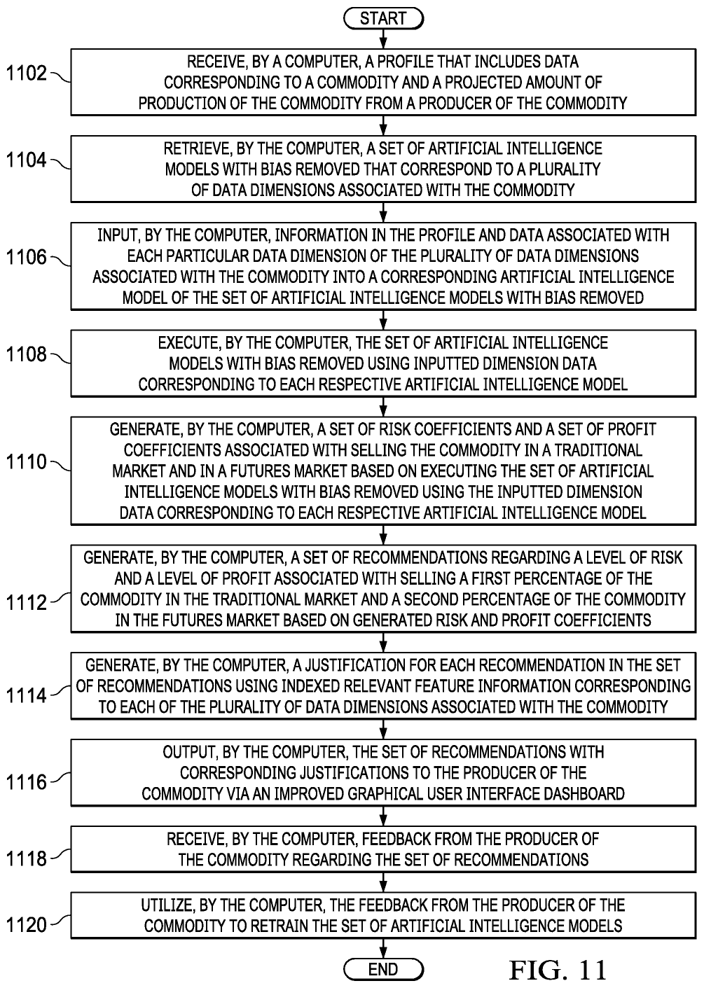

With reference now to FIG. 11, a flowchart illustrating an execution process is shown in accordance with an illustrative embodiment. The process shown in FIG. 11 may be implemented in a computer, such as, for example, server 104 in FIG. 1, data processing system 200 in FIG. 2, or server 302 in FIG. 3.

The process begins when the computer receives a profile that includes data corresponding to a commodity and a projected amount of production of the commodity from a producer of the commodity (step 1102). In addition, the computer retrieves a set of artificial intelligence models with bias removed that correspond to a plurality of data dimensions associated with the commodity (step 1104). Further, the computer inputs information in the profile and data associated with each particular data dimension of the plurality of data dimensions associated with the commodity into a corresponding artificial intelligence model of the set of artificial intelligence models with bias removed (step 1106).

The computer executes the set of artificial intelligence models with bias removed using inputted dimension data corresponding to each respective artificial intelligence model (step 1108). The computer generates a set of risk coefficients and a set of profit coefficients associated with selling the commodity in a traditional market and in a futures market based on executing the set of artificial intelligence models with bias removed using the inputted dimension data corresponding to each respective artificial intelligence model (step 1110).

Afterward, the computer generates a set of recommendations regarding a level of risk and a level of profit associated with selling a first percentage of the commodity in the traditional market and a second percentage of the commodity in the futures market based on generated risk and profit coefficients (step 1112). Moreover, the computer generates a justification for each recommendation in the set of recommendations using indexed relevant feature information corresponding to each of the plurality of data dimensions associated with the commodity (step 1114).

The computer outputs the set of recommendations with corresponding justifications to the producer of the commodity via an improved graphical user interface dashboard (step 1116). The computer receives feedback from the producer of the commodity regarding the set of recommendations (step 1118). The computer utilizes the feedback from the producer of the commodity to retrain the set of artificial intelligence models (step 1120). Thereafter, the process terminates.

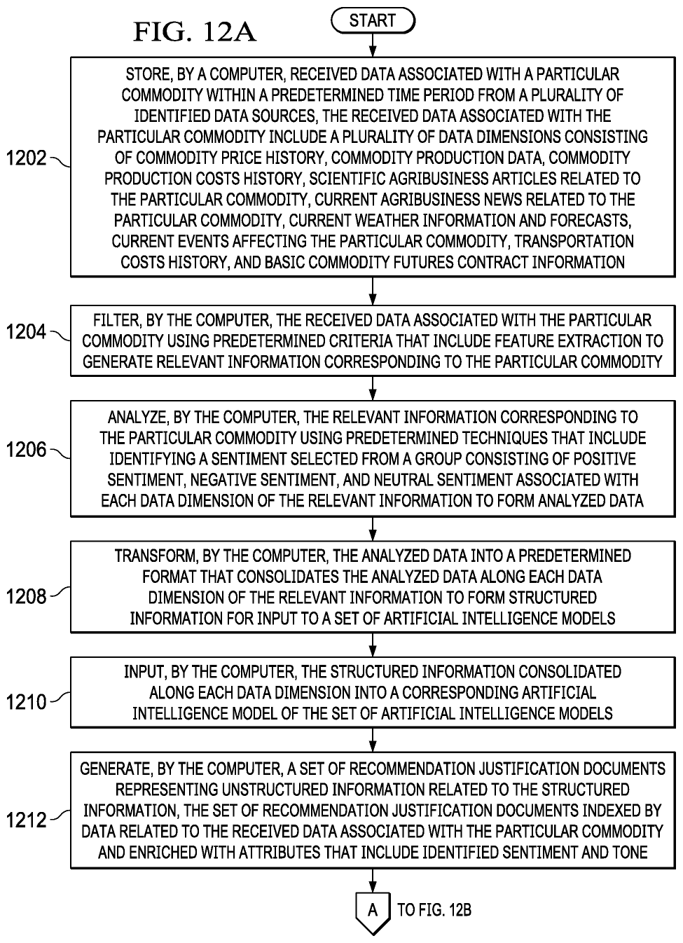

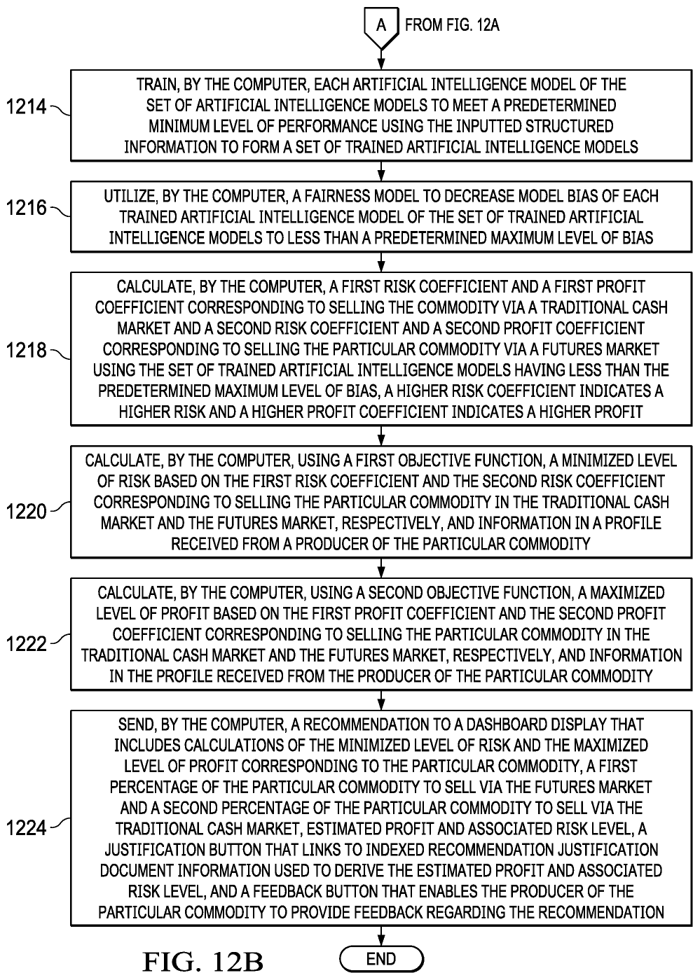

With reference now to FIGS. 12A-12B, a flowchart illustrating a process for generating a commodity recommendation dashboard is shown in accordance with an illustrative embodiment. The process shown in FIGS. 12A-12B may be implemented in a computer, such as, for example, server 104 in FIG. 1, data processing system 200 in FIG. 2, or server 302 in FIG. 3.

The process begins when the computer stores received data associated with a particular commodity within a predetermined time period from a plurality of identified data sources (step 1202). The received data associated with the particular commodity include a plurality of data dimensions consisting of commodity price history, commodity production data, commodity production costs history, scientific agribusiness articles related to the particular commodity, current agribusiness news related to the particular commodity, current weather information and forecasts, current events affecting the particular commodity, transportation costs history, and basic commodity futures contract information. The computer filters the received data associated with the particular commodity using predetermined criteria that include feature extraction to generate relevant information corresponding to the particular commodity (step 1204).

The computer analyzes the relevant information corresponding to the particular commodity using predetermined techniques that include identifying a sentiment selected from a group consisting of positive sentiment, negative sentiment, and neutral sentiment associated with each data dimension of the relevant information to form analyzed data (step 1206). The computer transforms the analyzed data into a predetermined format that consolidates the analyzed data along each data dimension of the relevant information to form structured information for input to a set of artificial intelligence models (step 1208). The computer inputs the structured information consolidated along each data dimension into a corresponding artificial intelligence model of the set of artificial intelligence models (step 1210).

The computer generates a set of recommendation justification documents representing unstructured information related to the structured information (step 1212). The set of recommendation justification documents are indexed by data related to the received data associated with the particular commodity and enriched with attributes that include identified sentiment and tone. The computer trains each artificial intelligence model of the set of artificial intelligence models to meet a predetermined minimum level of performance using the inputted structured information to form a set of trained artificial intelligence models (step 1214).

Afterward, the computer utilizes a fairness model to decrease model bias of each trained artificial intelligence model of the set of trained artificial intelligence models to less than a predetermined maximum level of bias (step 1216). The predetermined maximum level of bias may be, for example, zero bias. The computer calculates a first risk coefficient and a first profit coefficient corresponding to selling the particular commodity via a traditional cash market and a second risk coefficient and a second profit coefficient corresponding to selling the commodity via a futures market using the set of trained artificial intelligence models having less than the predetermined maximum level of bias (step 1218). A higher risk coefficient indicates a higher risk and a higher profit coefficient indicates a higher profit. Conversely, a lower risk coefficient indicates a lower risk and a lower profit coefficient indicates a lower profit.

Then, the computer, using a first objective function, calculates a minimized level of risk based on the first risk coefficient and the second risk coefficient corresponding to selling the particular commodity in the traditional cash market and the futures market, respectively, and information in a profile received from a producer of the particular commodity (step 1220). The computer, using a second objective function, also calculates a maximized level of profit based on the first profit coefficient and the second profit coefficient corresponding to selling the particular commodity in the traditional cash market and the futures market, respectively, and information in the profile received from the producer of the particular commodity (step 1222).

The computer sends a recommendation to a dashboard display (step 1224). The dashboard display includes calculations of the minimized level of risk and the maximized level of profit corresponding to the particular commodity, a first percentage of the particular commodity to sell via the futures market and a second percentage of the particular commodity to sell via the traditional cash market, estimated profit and associated risk level, a justification button that links to indexed recommendation justification document information used to derive the estimated profit and associated risk level, and a feedback button that enables the producer of the particular commodity to provide feedback regarding the recommendation. Thereafter, the process terminates.

Thus, illustrative embodiments of the present invention provide a computer-implemented method, computer system, and computer program product for generating an improved graphical user interface that guides agribusiness producer prescriptive decisions regarding selling a particular commodity via a futures contract, a traditional cash market, or a combination of both. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for guiding agribusiness producer decisions by an agribusiness producer, the computer-implemented method comprising:
calculating, by a computer, a first risk coefficient and a first profit coefficient corresponding to selling a commodity via a traditional cash market and a second risk coefficient and a second profit coefficient corresponding to selling the commodity via a futures market using a set of trained artificial intelligence models comprising a deep analysis and data optimization component decreasing artificial intelligence model bias using a fairness measure module that iteratively applies a fairness model to each of the set of trained artificial intelligence models until each artificial intelligence model has less than a predetermined maximum level of bias, wherein the fairness model executes validation and corrections on each of the set of trained artificial intelligence models, wherein the fairness model provides an interaction to eliminate bias by correcting each of the set of trained artificial intelligence models until ready to be used on its corresponding data dimension and for each target objective of profit and risk regarding futures market percentage of negotiation until ready to deliver coefficients for profit and risk;
calculating, by the computer, using a first objective function, a minimized level of risk based on the first risk coefficient and the second risk coefficient corresponding to selling the commodity in the traditional cash market and the futures market, respectively, and information in a profile received from a producer of the commodity;
calculating, by the computer, using a second objective function, a maximized level of profit based on the first profit coefficient and the second profit coefficient corresponding to selling the commodity in the traditional cash market and the futures market, respectively, and information in the profile received from the producer of the commodity; and
sending, by the computer, a recommendation to a graphical user interface comprising a dashboard display that includes calculations of the minimized level of risk and the maximized level of profit corresponding to the commodity, a first percentage of the commodity to sell via the futures market and a second percentage of the commodity to sell via the traditional cash market, estimated profit and associated risk level, a justification button that links to indexed recommendation justification document information used to derive the estimated profit and associated risk level, and a feedback button that enables the producer of the commodity to provide feedback regarding the recommendation, wherein the recommendation, the justification button and the feedback button are used by the agribusiness producer to control risk by using the feedback button to send the interaction including a feedback as to whether the recommendation was valuable or not, the feedback being processed and utilized as input to retrain the artificial intelligence models.

2. The computer-implemented method of claim 1, wherein each of the set of trained artificial intelligence models corresponds to a respective data dimension in a plurality of data dimensions associated with the commodity.

3. The computer-implemented method of claim 1 further comprising:
training, by the computer, each artificial intelligence model of a set of artificial intelligence models to meet a predetermined minimum level of performance using structured information to form the set of trained artificial intelligence models.

4. The computer-implemented method of claim 3 further comprising:
generating, by the computer, a set of recommendation justification documents representing unstructured information related to the structured information, the set of recommendation justification documents indexed by data related to received data associated with the commodity and enriched with attributes that include identified sentiment and tone.

5. The computer-implemented method of claim 1 further comprising:
storing, by the computer, received data associated with the commodity within a predetermined time period from a plurality of identified data sources, the received data associated with the commodity include a plurality of data dimensions consisting of commodity price history, commodity production data, commodity production costs history, scientific agribusiness articles related to the commodity, current agribusiness news related to the commodity, current weather information and forecasts, current events affecting the commodity, transportation costs history, and basic commodity futures contract information;
filtering, by the computer, the received data associated with the commodity using predetermined criteria that include feature extraction to generate relevant information corresponding to the commodity;
analyzing, by the computer, the relevant information corresponding to the commodity using predetermined techniques that include identifying a sentiment selected from a group consisting of positive sentiment, negative sentiment, and neutral sentiment associated with each data dimension of the relevant information to form analyzed data;
transforming, by the computer, the analyzed data into a predetermined format that consolidates the analyzed data along each data dimension of the relevant information to form structured information; and
inputting, by the computer, the structured information consolidated along each data dimension into a corresponding artificial intelligence model of a set of artificial intelligence models.

6. The computer-implemented method of claim 1 further comprising:
extracting, by the computer, relevant feature information corresponding to each of a plurality of data dimensions associated with the commodity from processed data using natural language processing that includes language identification, syntax processing, semantic parsing, feature extraction, and sentiment identification; and
indexing, by the computer, the relevant feature information corresponding to each of the plurality of data dimensions associated with the commodity for use as justifications of recommendations to the producer of the commodity.

7. The computer-implemented method of claim 1, wherein the predetermined maximum level of bias is no bias.

8. The computer-implemented method of claim 1 further comprising:
receiving, by the computer, a profile that includes data corresponding to the commodity and a projected amount of production of the commodity from the producer of the commodity;
retrieving, by the computer, a set of artificial intelligence models with bias removed that correspond to a plurality of data dimensions associated with the commodity; and
inputting, by the computer, information in the profile and data associated with each data dimension of the plurality of data dimensions associated with the commodity into a corresponding artificial intelligence model of the set of artificial intelligence models with bias removed.

9. The computer-implemented method of claim 8 further comprising:
executing, by the computer, the set of artificial intelligence models with bias removed using inputted dimension data corresponding to each respective artificial intelligence model; and
generating, by the computer, a set of risk coefficients and a set of profit coefficients associated with selling the commodity via the futures market and the traditional cash market based on executing the set of artificial intelligence models with bias removed using the inputted dimension data corresponding to each respective artificial intelligence model.

10. The computer-implemented method of claim 9 further comprising:
generating, by the computer, a set of recommendations regarding a level of risk and a level of profit associated with selling the first percentage of the commodity via the futures market and a second percentage of the commodity in the traditional cash market based on generated risk and profit coefficients;
generating, by the computer, a justification for each recommendation in the set of recommendations using indexed relevant feature information corresponding to each of the plurality of data dimensions associated with the commodity; and
outputting, by the graphical user interface, the set of recommendations with corresponding justification buttons to the agribusiness producer of the commodity, wherein the set of recommendations and corresponding justification buttons are used by the agribusiness producer to control risk.

11. The computer-implemented method of claim 10 further comprising:
receiving, by the computer, feedback from the producer of the commodity regarding the set of recommendations; and
utilizing, by the computer, the feedback from the producer of the commodity to retrain the set of artificial intelligence models.

12. A computer system for guiding agribusiness producer decisions by an agribusiness producer, the computer system comprising:
a bus system;
a storage device connected to the bus system, wherein the storage device stores program instructions; and
a processor connected to the bus system, wherein the processor executes the program instructions to:
calculate a first risk coefficient and a first profit coefficient corresponding to selling a commodity via a traditional cash market and a second risk coefficient and a second profit coefficient corresponding to selling the commodity via a futures market using a set of trained artificial intelligence models comprising a deep analysis and data optimization component decreasing artificial intelligence model bias using a fairness measure module that iteratively applies a fairness model to each of the set of trained artificial intelligence models until each artificial intelligence model has Jess than a predetermined maximum level of bias, wherein the fairness model executes validation and corrections on each of the set of trained artificial intelligence models, wherein the fairness model provides an interaction to eliminate bias by correcting each of the set of trained artificial intelligence models until ready to be used on its corresponding data dimension and for each target objective of profit and risk regarding futures market percentage of negotiation until ready to deliver coefficients for profit and risk;
calculate, using a first objective function, a minimized level of risk based on the first risk coefficient and the second risk coefficient corresponding to selling the commodity in the traditional cash market and the futures market, respectively, and information in a profile received from a producer of the commodity;
calculate, using a second objective function, a maximized level of profit based on the first profit coefficient and the second profit coefficient corresponding to selling the commodity in the traditional cash market and the futures market, respectively, and information in the profile received from the producer of the commodity; and
send a recommendation to a graphical user interface comprising a dashboard display that includes calculations of the minimized level of risk and the maximized level of profit corresponding to the commodity, a first percentage of the commodity to sell via the futures market and a second percentage of the commodity to sell via the traditional cash market, estimated profit and associated risk level, a justification button that links to indexed recommendation justification document information used to derive the estimated profit and associated risk level, and a feedback button that enables the producer of the commodity to provide the interaction including a feedback regarding the recommendation, wherein the recommendation, the justification button and the feedback button are used by the agribusiness producer to control risk by using the feedback button to send the interaction including a feedback as to whether the recommendation was valuable or not, the feedback being processed and utilized as input to retrain the artificial intelligence models.

13. The computer system of claim 12, wherein each of the set of trained artificial intelligence models corresponds to a respective data dimension in a plurality of data dimensions associated with the commodity.

14. The computer system of claim 12, wherein the processor further executes the program instructions to:
train each artificial intelligence model of a set of artificial intelligence models to meet a predetermined minimum level of performance using structured information to form the set of trained artificial intelligence models.

15. The computer system of claim 14, wherein the processor further executes the program instructions to:
generate a set of recommendation justification documents representing unstructured information related to the structured information, the set of recommendation justification documents indexed by data related to received data associated with the commodity and enriched with attributes that include identified sentiment and tone.

16. A computer program product for guiding agribusiness producer decisions by an agribusiness producer, the computer program product comprising a computer readable storage medium having program instructions embodied therewith, the program instructions executable by a computer to cause the computer to perform a method comprising:
calculating, by the computer, a first risk coefficient and a first profit coefficient corresponding to selling a commodity via a traditional cash market and a second risk coefficient and a second profit coefficient corresponding to selling the commodity via a futures market using a set of trained artificial intelligence models comprising a deep analysis and data optimization component decreasing artificial intelligence model bias using a fairness measure module that iteratively applies a fairness model to each of the set of trained artificial intelligence models until each artificial intelligence model has less than a predetermined maximum level of bias, wherein the fairness model executes validation and corrections on each of the set of trained artificial intelligence models, wherein the fairness model provides an interaction to eliminate bias by correcting each of the set of trained artificial intelligence models until ready to be used on its corresponding data dimension and for each target objective of profit and risk regarding futures market percentage of negotiation until ready to deliver coefficients for profit and risk;
calculating, by the computer, using a first objective function, a minimized level of risk based on the first risk coefficient and the second risk coefficient corresponding to selling the commodity in the traditional cash market and the futures market, respectively, and information in a profile received from a producer of the commodity;
calculating, by the computer, using a second objective function, a maximized level of profit based on the first profit coefficient and the second profit coefficient corresponding to selling the commodity in the traditional cash market and the futures market, respectively, and information in the profile received from the producer of the commodity; and
sending, by the computer, a recommendation to a graphical user interface comprising a dashboard display that includes calculations of the minimized level of risk and the maximized level of profit corresponding to the commodity, a first percentage of the commodity to sell via the futures market and a second percentage of the commodity to sell via the traditional cash market, estimated profit and associated risk level, a justification button that links to indexed recommendation justification document information used to derive the estimated profit and associated risk level, and a feedback button that enables the producer of the commodity to provide feedback regarding the recommendation, wherein the recommendation, the justification button and the feedback button are used by the agribusiness producer to control risk by using the feedback button to send the interaction including a feedback as to whether the recommendation was valuable or not, the feedback being processed and utilized as input to retrain the artificial intelligence models.

17. The computer program product of claim 16, wherein each of the set of trained artificial intelligence models corresponds to a respective data dimension in a plurality of data dimensions associated with the commodity.

18. The computer program product of claim 16 further comprising:
training, by the computer, each artificial intelligence model of a set of artificial intelligence models to meet a predetermined minimum level of performance using structured information to form the set of trained artificial intelligence models.

19. The computer program product of claim 18 further comprising:
generating, by the computer, a set of recommendation justification documents representing unstructured information related to the structured information, the set of recommendation justification documents indexed by data related to received data associated with the commodity and enriched with attributes that include identified sentiment and tone.

20. The computer program product of claim 16 further comprising:
storing, by the computer, received data associated with the commodity within a predetermined time period from a plurality of identified data sources, the received data associated with the commodity include a plurality of data dimensions consisting of commodity price history, commodity production data, commodity production costs history, scientific agribusiness articles related to the commodity, current agribusiness news related to the commodity, current weather information and forecasts, current events affecting the commodity, transportation costs history, and basic commodity futures contract information;
filtering, by the computer, the received data associated with the commodity using predetermined criteria that include feature extraction to generate relevant information corresponding to the commodity;
analyzing, by the computer, the relevant information corresponding to the commodity using predetermined techniques that include identifying a sentiment selected from a group consisting of positive sentiment, negative sentiment, and neutral sentiment associated with each data dimension of the relevant information to form analyzed data;
transforming, by the computer, the analyzed data into a predetermined format that consolidates the analyzed data along each data dimension of the relevant information to form structured information; and
inputting, by the computer, the structured information consolidated along each data dimension into a corresponding artificial intelligence model of a set of artificial intelligence models.
